(19) United States
(12) Patent Application Publication
(10) Pub. No.: US 2009/0320835 A1
(43) Pub. Date: Dec. 31, 2009

(54) Full-Face Germproof Respirator

(76) Inventor: Jing-Jyr LIN, Taoyuan County (TW)

Correspondence Address: SINORICA, LLC, 2275 Research Blvd., Suite 500, ROCKVILLE, MD, 20850, US

(21) Appl. No.: 12/351,021

(22) Filed: Jan. 9, 2009

(30) Foreign Application Priority Data
Jun. 30, 2008 (CN) 200820116487.X

(51) Int. Cl. A62B 7/10; A62B 18/08

(52) U.S. Cl. 128/201.15; 128/201.25

(57) ABSTRACT

The present invention relates to a full-face germproof respirator, which comprises a respirator body and a three-dimensional mask. The three-dimensional mask is assembled on the respirator body. The full-face germproof respirator is disposable owing to its adoption of low-cost materials and fabrication. All joints of the full-face germproof respirator are heat-sealed, achieving excellent germproof effects. Besides, the full-face germproof respirator adopts the three-dimensional mask, and thereby mists produced by a user are reduced.

### FIELD OF THE INVENTION

The present invention relates generally to a germproof respirator, and particularly to a full-face germproof respirator.

### BACKGROUND OF THE INVENTION

There exist a variety of full-face respirators in the marketplace. As shown in FIGS. 1 and 2, the full-face respirator 1′ comprises a respirator body 10′ and a filter part 12′. Some full-face respirators 1′ adopt filter pots as the filter part 12′ (as shown in FIG. 1), and adopt fireproof materials as the respirator body 10′. The full-face respirators 1′ made this way is costly, and thereby cannot afford disposable applications. When the full-face respirators 1′ is to be used next time, they have to be cleaned in advance, spending extra time.

In addition, the filter part 12′ of the full-face respirator 1′ adopts a planar filter flake or a gauze mask (as shown in FIG. 2). The filter part 12′ of the full-face respirator 12′ is improved in comparison with the one in FIG. 1, and thus reducing the manufacturing costs. However, its disadvantage is that the filter flake or the gauze mask is too close to the mouth and nose of the user. When the user breaths, the small space for air circulation tends to produce mist in the full-face respirator 1′, and thus hindering the user's visibility.

Besides, the joint of current full-face respirators 1′ adopt stitching. Thereby, external germs or viruses still can penetrate through the stitching gaps, limiting their applications to preventing smoke or dusts.

The wearing opening of most full-face respirator 1′ has a contraction part 103′, which makes a user inconvenient in wearing. When the user uses the full-face respirator 1′, his neck may feel uncomfortable due to the material and elasticity of the contraction part 103′. In addition, the filter part 12′ has a strap 121′ to tie behind the user's head. Although it can secure the full-face respirator 1′, after using a period of time, the strap 121′ may slide down the user's head, and thus moving the full-face respirator 1′. As a result, the full-face respirator 1′ can no longer cover the user's mouth and nose completely, making germs or viruses enter the full-face respirator 1′ and endanger the user's health.

Most full-face respirators 1′ are opaque, hence a window part 101′ is set on the respirator body 10′. However, if the window part 101′ is too small, the user's visibility will be affected, causing danger to the user.

The prior art described above has the mere efficacy of avoiding smokes, while it has the problems of hindering a user's visibility and other drawbacks due to substantial amount of mists exhaled by the user in the full-face respirator. Accordingly, the present invention provides a full-face germproof respirator, which has excellent germproof effects and can reduce mists exhaled by the user. In addition, owing to its low manufacturing costs, the full-face germproof respirator can be disposable.

### SUMMARY

An objective of the present invention is to provide a full-face germproof respirator, which uses cheap materials and simple assembly processes for reducing manufacturing costs. Because of its low costs, it is disposable, avoiding residual germs or viruses on the full-face germproof respirator. Thereby, a user will not use the full-face germproof respirator twice and will not infected by germs or viruses.

Another objective of the present invention is to provide a full-face germproof respirator. All joints of the full-face germproof respirator are heat-sealed. Thereby, external germs or viruses cannot enter through the joints, and excellent germproof effects can be achieved.

Another objective of the present invention is to provide a full-face germproof respirator, which has a three-dimensional mask, reducing mists exhaled by a user.

In order to achieve the objectives described above, the present invention provides a full-face germproof respirator, which comprises a respirator body and a three-dimensional mask. The respirator body includes a wearing opening, an assembly opening, and one or more sealing openings. The three-dimensional mask is set on the assembly opening. The sealing openings and the joint between the three-dimensional mask and the assembly opening are heat-sealed. The three-dimensional mask has one or more straps, used for securing the three-dimensional mask on the respirator body.

### BRIEF DESCRIPTION OF THE DRAWINGS

FIG. 1 shows a three-dimensional exterior view of a full-face respirator according to the prior art;

FIG. 2 shows a three-dimensional exterior view of another full-face respirator according to the prior art;

FIG. 3A shows a three-dimensional exterior view of the full-face respirator according to a preferred embodiment of the present invention;

FIG. 3B shows an application view of the full-face respirator according to a preferred embodiment of the present invention;

FIG. 4A shows another three-dimensional exterior view of the full-face respirator according to a preferred embodiment of the present invention;

FIG. 4B shows another three-dimensional exterior view of the full-face respirator according to a preferred embodiment of the present invention;

FIG. 5 shows another three-dimensional exterior view of the full-face respirator according to a preferred embodiment of the present invention;

FIG. 6A shows an application view of the full-face respirator according to another preferred embodiment of the present invention;

FIG. 6B shows a partial enlarged view of the full-face respirator according to another preferred embodiment of the present invention;

FIG. 7A shows an application view of the full-face respirator according to another preferred embodiment of the present invention;

FIG. 7B shows a partial enlarged view of the full-face respirator according to another preferred embodiment of the present invention;

FIG. 8 shows a three-dimensional exterior view of the full-face respirator according to another preferred embodiment of the present invention;

FIG. 9A shows a three-dimensional exterior view of the full-face respirator according to another preferred embodiment of the present invention;

FIG. 9B shows another three-dimensional exterior view of the full-face respirator according to another preferred embodiment of the present invention;

FIG. 10 shows a three-dimensional exterior view of the full-face respirator according to another preferred embodiment of the present invention;

FIG. 11 shows a three-dimensional exterior view of the full-face respirator according to another preferred embodiment of the present invention;

FIG. 12 shows an application view of the full-face respirator according to another preferred embodiment of the present invention;

FIG. 13 shows a three-dimensional exterior view of the full-face respirator according to another preferred embodiment of the present invention;

FIG. 14 shows a three-dimensional exterior view of the full-face respirator according to another preferred embodiment of the present invention; and

FIG. 15 shows a three-dimensional exterior view of the full-face respirator according to another preferred embodiment of the present invention.

### DETAILED DESCRIPTION

In order to make the structure and characteristics as well as the effectiveness of the present invention to be further understood and recognized, the detailed description of the present invention is provided as follows along with preferred embodiments and accompanying figures.

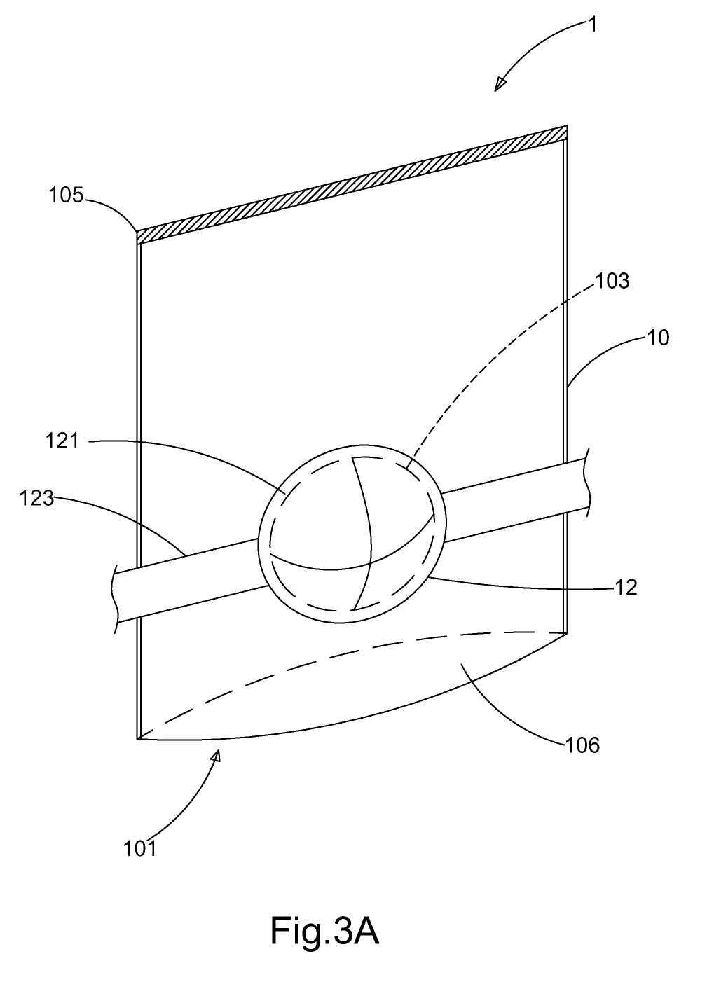

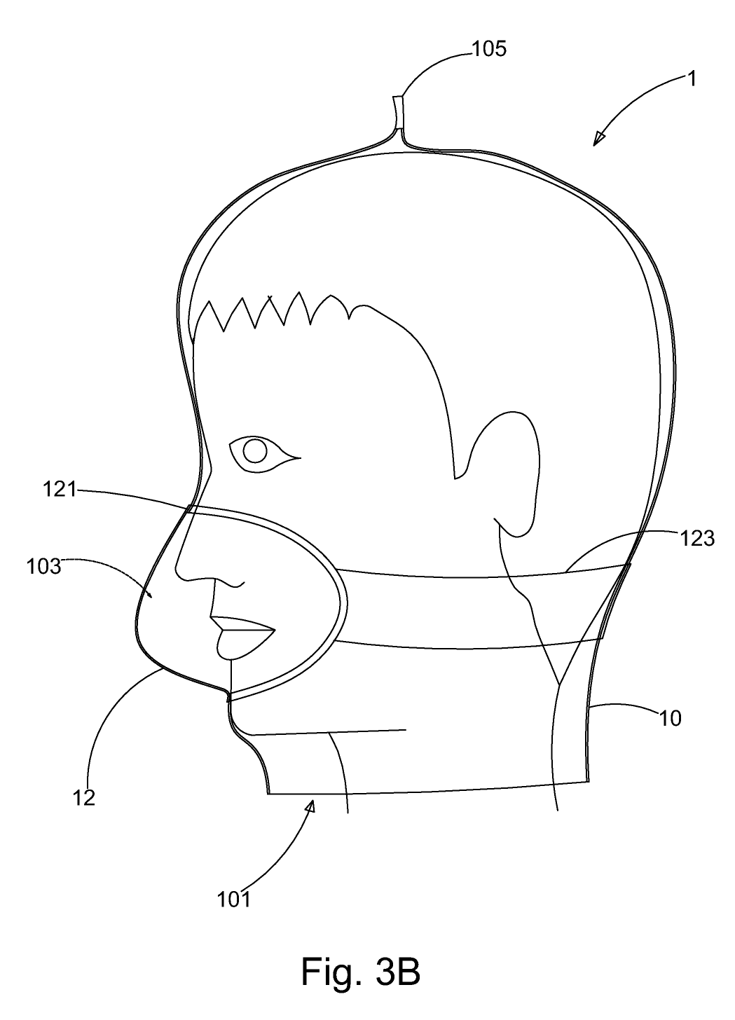

FIG. 3A shows a three-dimensional exterior view of the full-face respirator according to a preferred embodiment of the present invention. As shown in the figure, the present preferred embodiment provides a full-face germproof respirator 1, which comprises a respirator body 10 and a three-dimensional mask 12. The respirator body 10 includes a wearing opening 101, an assembly opening 103, and one or more sealing openings 105. Except the wearing opening 101 and the assembly opening 103, other openings located on the respirator body 10 are sealing openings 105. The sealing openings 105 are heat sealed by using high-frequency waves or ultrasonic waves. The three-dimensional mask 12 includes a joint part 121 set on the rim of the three-dimensional mask 12. The joint part 121 and the periphery of the assembly opening 103 are heat sealed using high-frequency waves or ultrasonic waves, so that the three-dimensional mask 12 is sealed closely with the assembly opening 103. Besides, any joint to the respirator body 10 are heat-sealed. Thereby, germs or viruses external to the full-face germproof respirator 1 cannot enter the respirator body 10, enhancing germproof effects of the full-face germproof respirator 1.

The reason why the three-dimensional mask 12 is adopted in the present preferred embodiment is that if the full-face germproof respirator 1 adopts a flat mask, when the user uses the full-face germproof respirator 1, a great amount of mists will be produced therein due to its proximity to mouth and nose, and hence hindering the user's visibility. Thereby, according to the present preferred embodiment, the three-dimensional mask 12 is adopted to minimize mist production in the full-face germproof respirator 1.

The three-dimensional mask 12 has one or more straps 123, set outside the respirator body 10 and parallel to the wearing opening 101, for securing the respirator body 10 and make the three-dimensional mask 12 cover a user's mouth and nose completely. The respirator body 10 has a transparent part 106. When the user uses the full-face germproof respirator 1, he/she can still see his/her environment clearly. The area of the transparent part 106 is the whole area of the side of the respirator body 10 with the assembly opening 103, and can be adjusted according to the user's demand.

FIG. 3B shows an application view of the full-face respirator according to a preferred embodiment of the present invention. As shown in the figure, when the user uses the full-face germproof respirator 1, the user's head wears the respirator body 10 through the wearing opening 103. Then, adjust and assemble the three-dimensional mask 12 and the assembly opening 103 to align with the user's mouth and nose, so that the three-dimensional mask 12 covers the user's mouth and nose completely. The three-dimensional mask 12 is used for filtering the air external to the full-face germproof respirator 1, and thereby toxic gases, germs, or viruses are prevented from entering the user's mouth and nose. After complete coverage of the three-dimensional mask 12 over the user's mouth and nose is confirmed, the strap 123 set on the three-dimensional mask 12 is put around or tied at a proper location behind the user's head for securing the respiration body 10 from slippage. Otherwise, the three-dimensional mask 12 may move when the respiration body 12 moves, and thus cannot cover the user's mouth and nose completely.

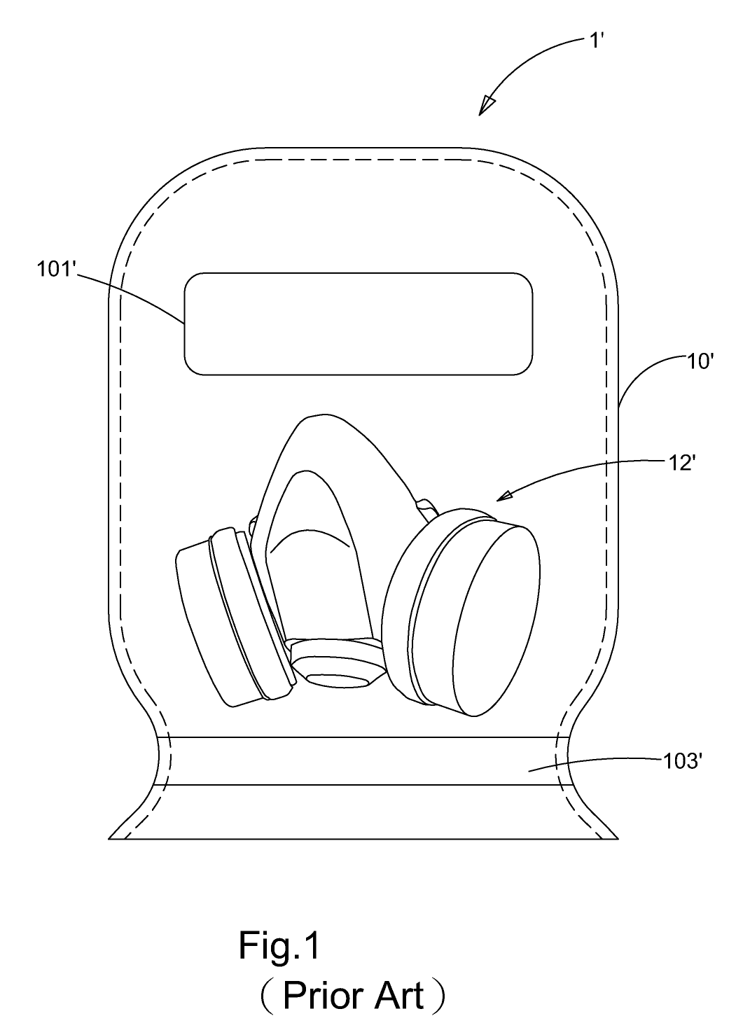

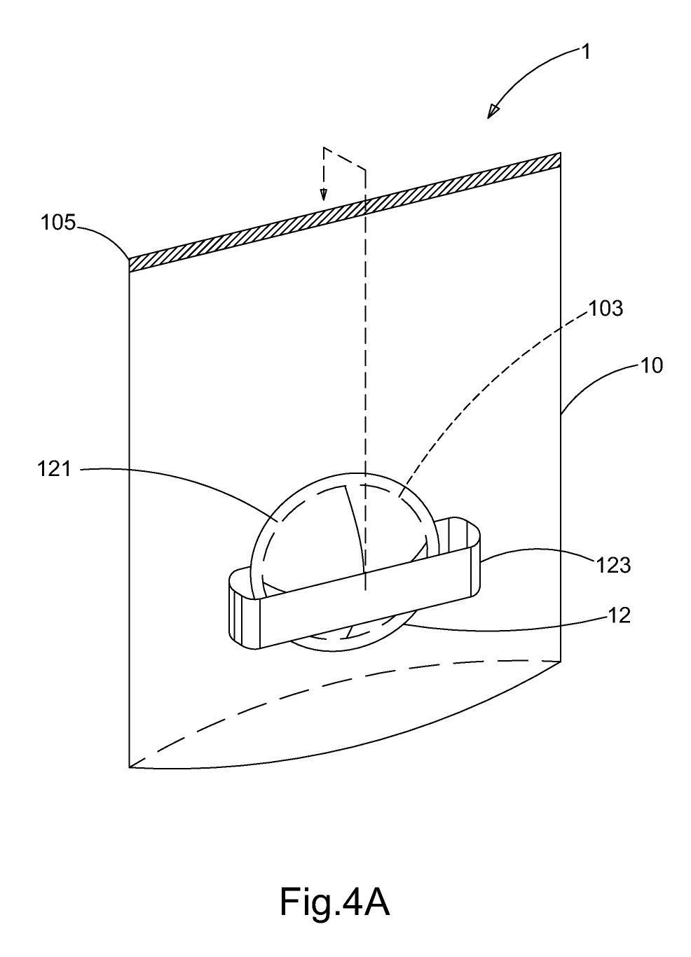

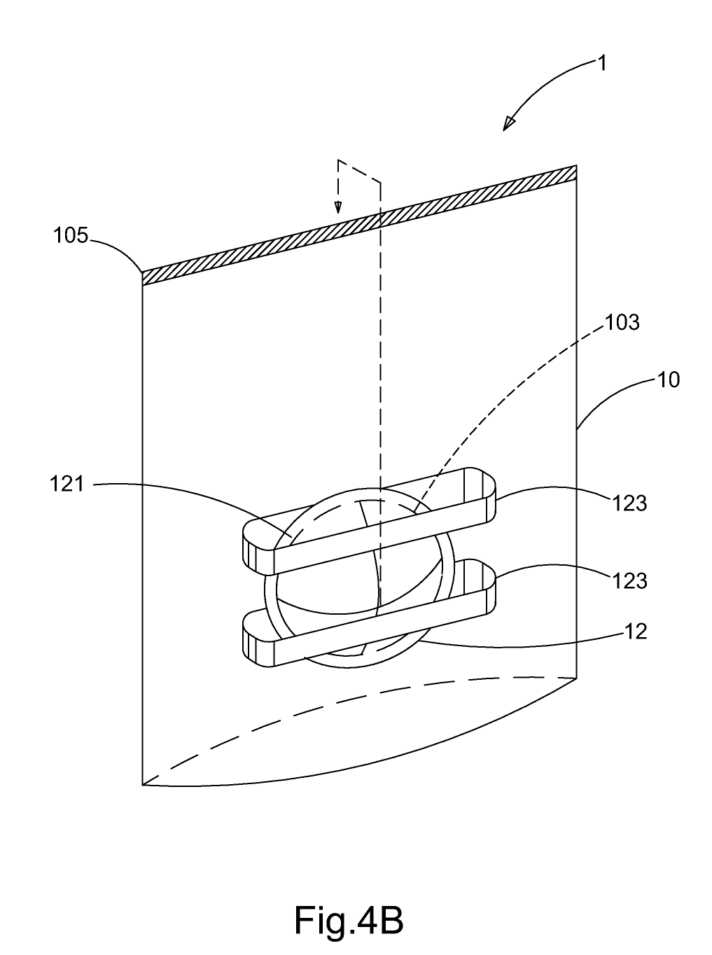

FIG. 4A shows another three-dimensional exterior view of the full-face respirator according to a preferred embodiment of the present invention. As shown in the figure, following the preferred embodiment of FIG. 1A, the strap 123 can be an elastic strap. One end of the strap 123 is fixed on one side of the three-dimensional mask 12, while the other end of the strap 123 is fixed on the other side of the three-dimensional mask 12. When the user wears the full-face germproof respirator 1, the strap 123 is pulled from the front of the head to the rear thereof, and is thus put around the user's head. Thereby, the three-dimensional mask 12 and the respirator body 10 are secured. In addition, FIG. 4B shows another three-dimensional exterior view of the full-face respirator according to a preferred embodiment of the present invention. As shown in the figure, following the preferred embodiment of FIG. 4B, the three-dimensional mask 12 has two straps 123. Thereby, forces can be applied evenly to the four corners of the three-dimensional mask 12, further ensuring that the three-dimensional mask 12 can protect the user's mouth and nose.

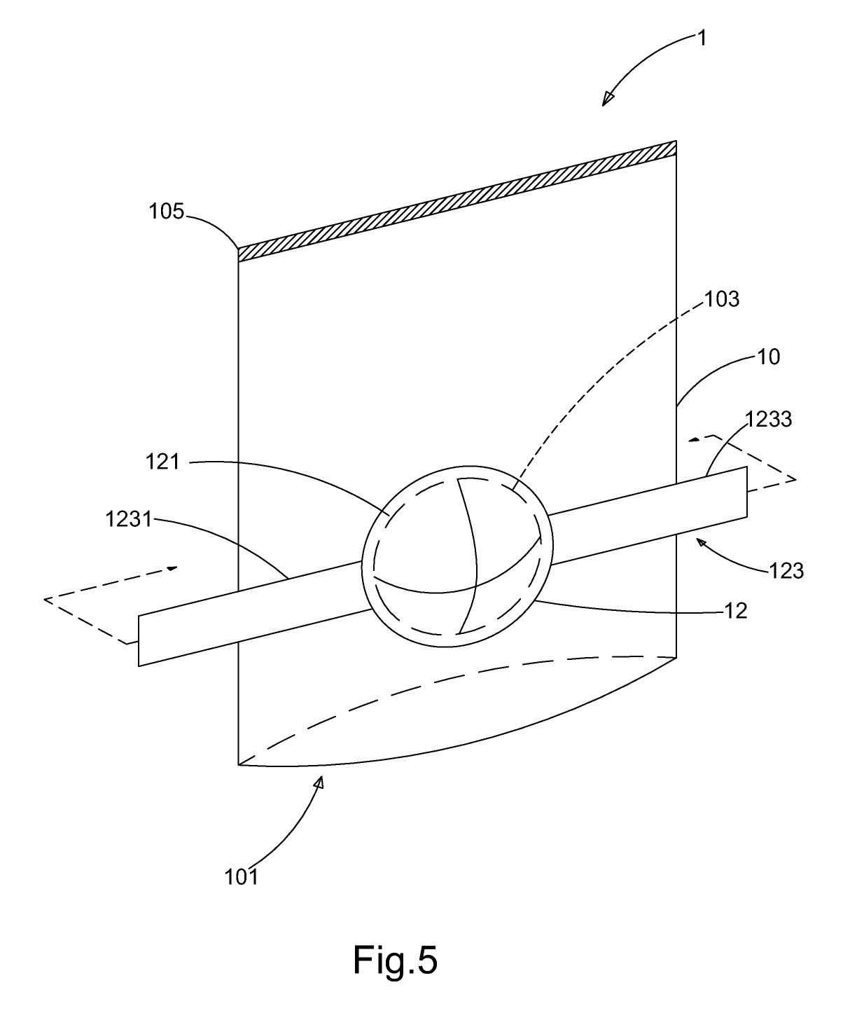

FIG. 5 shows another three-dimensional exterior view of the full-face respirator according to a preferred embodiment of the present invention. As shown in the figure, following the preferred embodiment of FIG. 1A, the strap 123 includes a first strap 1231 and a second strap 1233. The first strap 1231 is set on one side of the three-dimensional mask 12, while the second strap 1233 is set on the other side of the three-dimensional mask 12. When the user wears the full-face germproof respirator 1, the first strap 1231 and the second strap 1233 are pulled, respectively, from the front of the head to the rear thereof, and are connected for securing the three-dimensional mask 12 and the respirator body 10. The first strap 1231 and the second strap 1233 are straps with male and female buckles, respectively. Alternatively, they can be male and female velcros, respectively. Similar to FIG. 4B, according to the present preferred embodiment, two straps 123 can be used, and will not be described further.

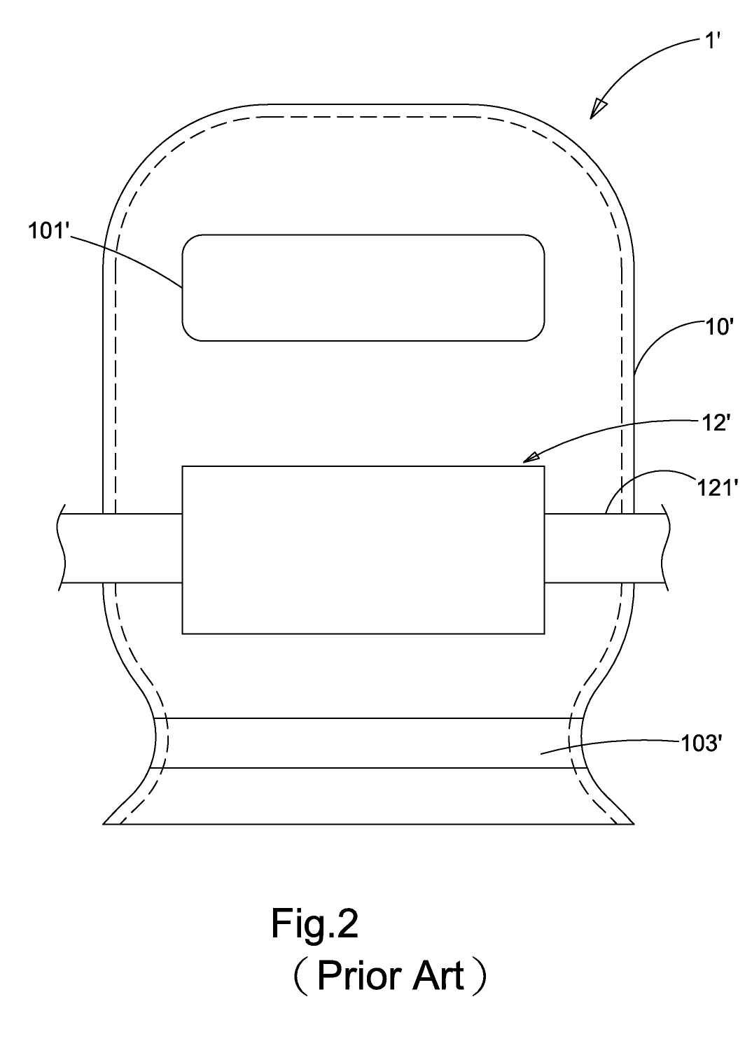

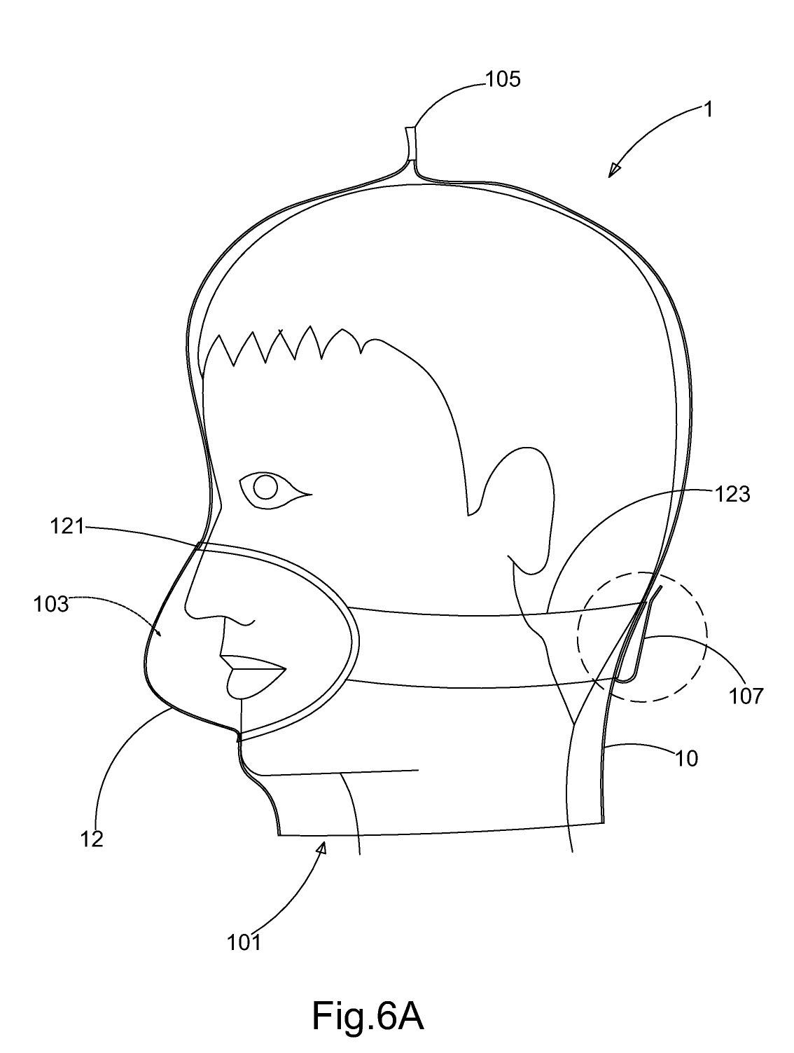

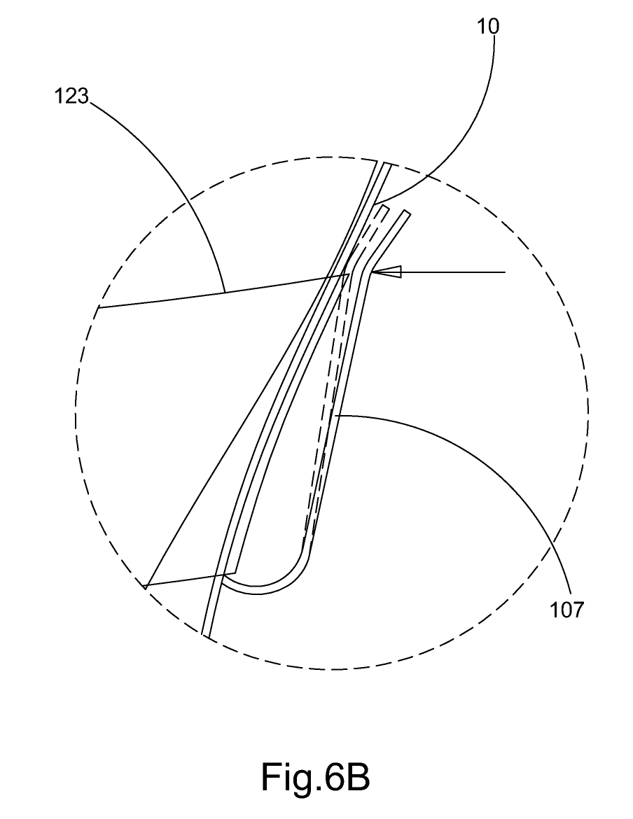

FIG. 6A shows an application view of the full-face respirator according to another preferred embodiment of the present invention. As shown in the figure, the difference between the full-face germproof respirator 1 according to the present preferred embodiment and the one according to the preferred embodiment of FIG. 3A is that, according to the present preferred embodiment, the respirator body 10 has a fixing part 107 set on the surface without the assembly opening 103 and corresponding to the assembly opening 103 used for assembling the three-dimensional mask 12. By FIG. 2A, when the user wear the full-face germproof respirator 1 at his/her head, because the strap 123 will slip down along the head shape of the user, and hence the best position for the fixing part 107 is under the user's head. Thereby, the respirator body 10 can be fixed without the worry of movement, which could make the three-dimensional mask 12 unable to cover the user's mouth and nose completely. According to the present preferred embodiment, if two straps 123 are applied, the number of the fixing part 107 can be increased to two for fixing the corresponding strap 123, respectively.

The fixing part 107 can be a hook, and the strap 123 can be hooked on the fixing part 107. The material of the fixing part 107 is a hard material such as plastics or metals. Alternatively, it can be an elastic material with uneasy deformability, such as aluminum or iron slabs. If the material of the fixing part 107 is a hard material, the fixing part 107 is U-shaped. In order to avoid the strap 123 from slipping out of the fixing part 107, the opening of the fixing part 107 should shrink. FIG. 6B shows a partial enlarged view of the full-face respirator according to another preferred embodiment of the present invention. As shown in the figure, if the material of the fixing part 107 is an elastic material, the fixing part 107 is still U-shaped. The strap 123 is hooked on the fixing part 107, and the fixing part 107 is pressed towards the direction of the respirator body 10 for securing the strap 123.

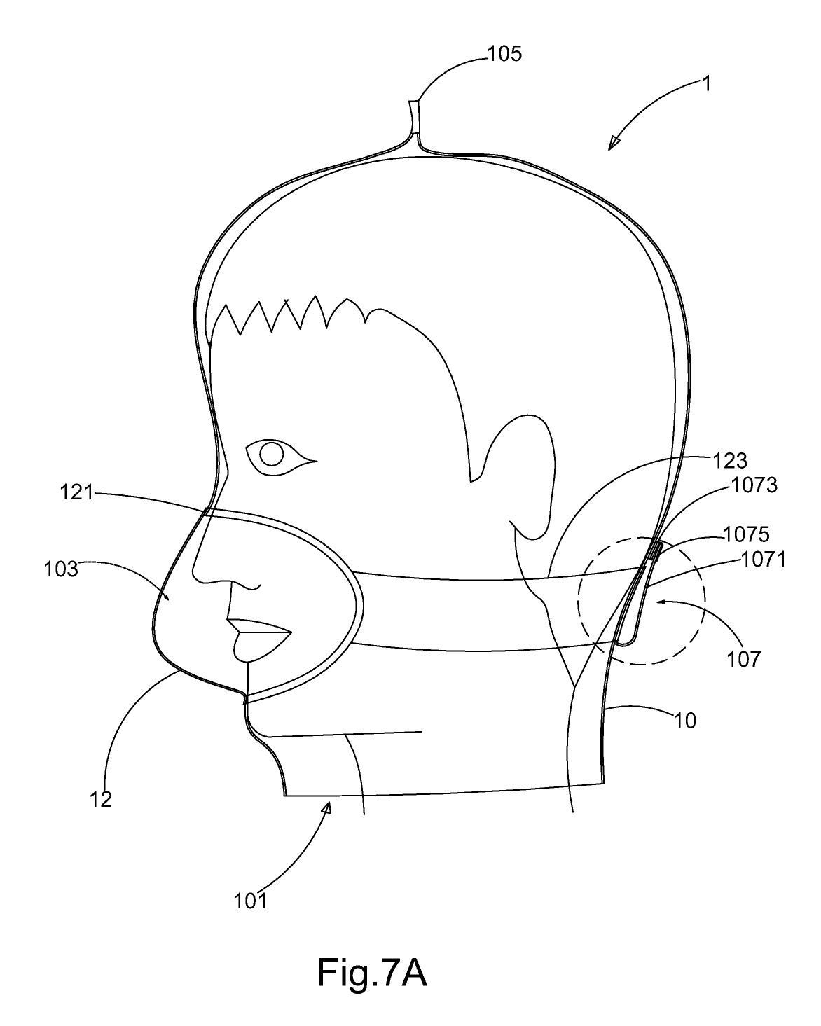

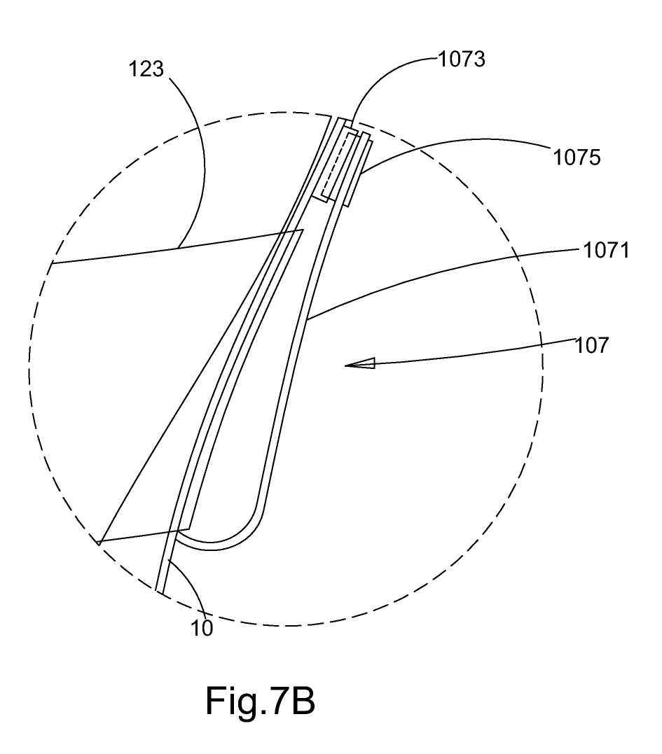

FIGS. 7A and 7B show an application view and a partial enlarged view of the full-face respirator according to another preferred embodiment of the present invention. When the material of the fixing part shown in FIGS. 6A and 6B is aged, it could crack or deform, making the strap 123 slip out of the fixing part 107. Thereby, the fixing part 107 according to the present preferred embodiment includes a fixing member 1071 and a buckle 1073. One end of the fixing member 1071 is set on the respirator body 10, while the other end of the fixing member 1071 has a buckle insert 1073 corresponding to the buckle member 1073. The fixing member 1071 extends over the strap 123. The buckle insert 1075 of the fixing member 1071 connects with the buckle member 1073. Thereby, the strap 123 is ensured not to move or depart from the fixing part 107.

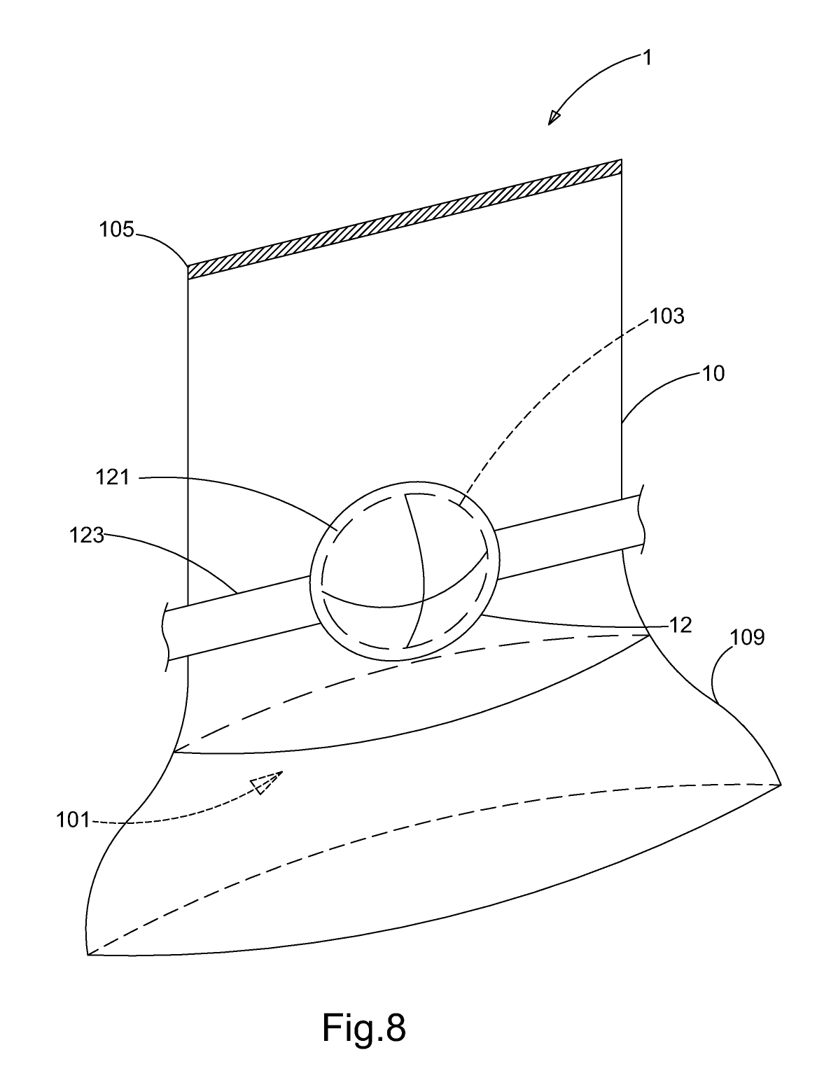

FIG. 8 shows a three-dimensional exterior view of the full-face respirator according to another preferred embodiment of the present invention. Ash shown in the figure, the difference between the full-face germproof respirator 1 according to the present preferred embodiment and the one according to the preferred embodiment of FIG. 3A is that, the protection area of the respirator body 10 according to the present preferred embodiment is larger than that of the full-face germproof respirator 1 according to the preferred embodiment of FIG. 3A. The full-face germproof respirator 1 according to the preferred embodiment of FIG. 3A only protects the user's head. On the other hand, the full-face germproof respirator 1 according to the present preferred embodiment also protects the user's shoulder. The full-face germproof respirator 1 according to the present preferred embodiment comprises a respirator body 10 and a three-dimensional mask 12. The respirator body 10 includes a wearing opening 101, an assembly opening 103, one or more sealing openings 105, and a shoulder shield 109. The three-dimensional mask 12 is assembled on the assembly opening 103 and has a strap 123. The shoulder shield 109 is adjacent to the wearing opening 101. When a user wears the full-face germproof respirator 1, the shoulder shield 109 covers the user's shoulder. Then the user wears protective clothing, which can cover the shoulder shield 109 of the full-face germproof respirator 1, for avoiding germs or viruses from entering the full-face germproof respirator 1.

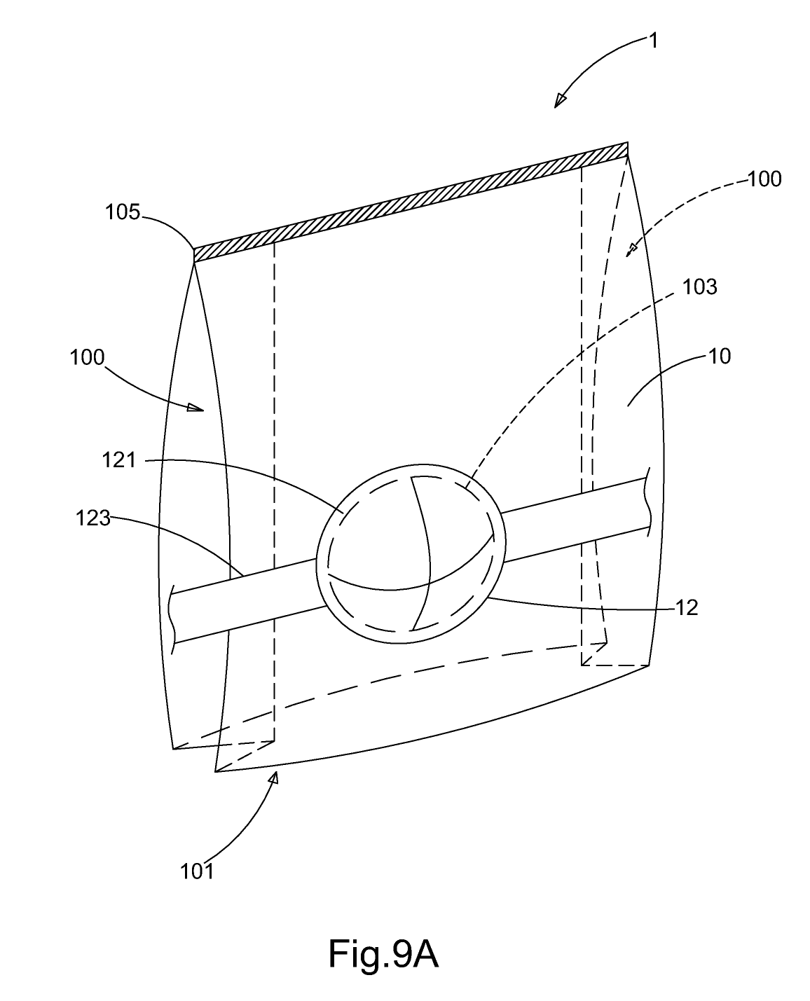

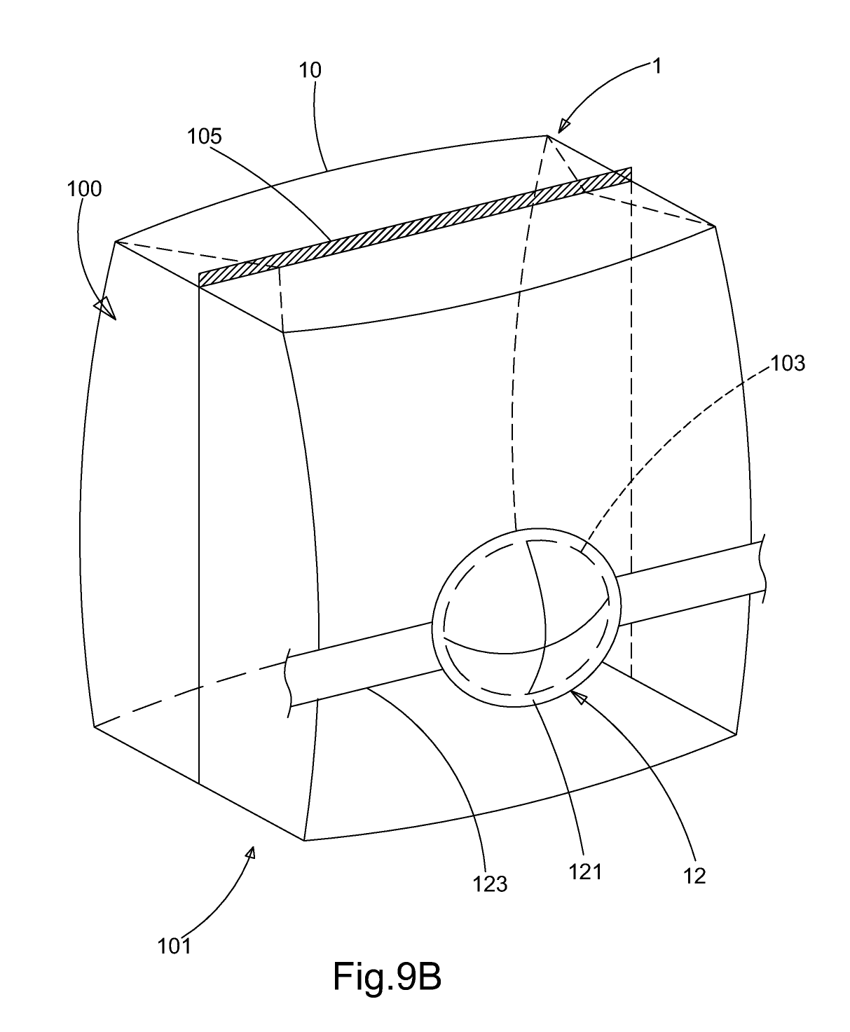

FIGS. 9A and 9B show a three-dimensional exterior view and another three-dimensional exterior view of the full-face respirator according to another preferred embodiment of the present invention. As shown in the figures, the difference between the full-face germproof respirator 1 according to the present preferred embodiment and the one according to the preferred embodiment of FIG. 3A is that, the unfolded volume of the full-face germproof respirator 1 according to the present preferred embodiment is greater than that of the full-face germproof respirator 1 according to the preferred embodiment of FIG. 3A. Two inward folded surfaces 100 are set on flanks of the respirator body 10. When the user wears the full-face germproof respirator 1, owing to set-up of said two inward folded surfaces 100, the respirator body 10 can be unfolded and form a flat surface on the top. After unfolding, the respirator body 10 has a greater volume, easier for the user's wearing. Thereby, the user who uses the full-face germproof respirator 1 can produce fewer mists during respiration.

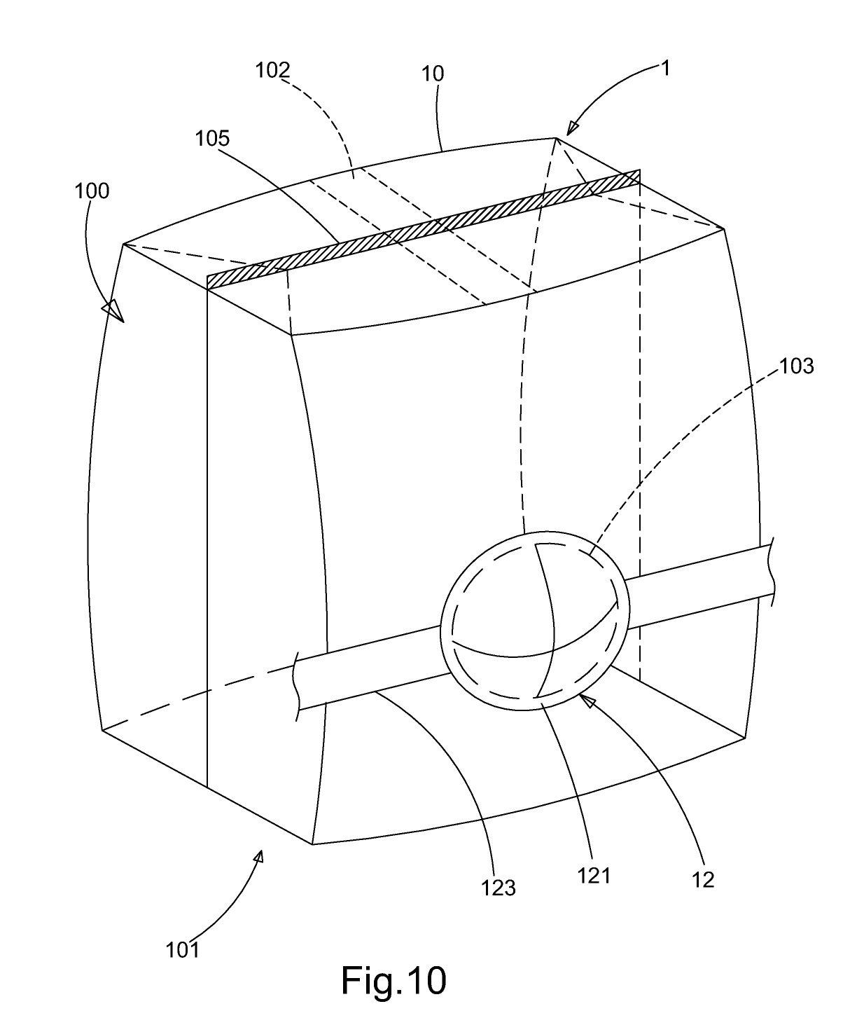

FIG. 10 shows a three-dimensional exterior view of the full-face respirator according to another preferred embodiment of the present invention. As shown in the figures, the difference between the full-face germproof respirator 1 according to the present preferred embodiment and the one according to the preferred embodiment of FIG. 9A is that, the full-face germproof respirator 1 according to the present preferred embodiment has support 102 on its top. The material of the support 102 can be elastic material with uneasy deformability, such as aluminum slabs, for easier unfolding of the respirator body 10. The top of the respirator body 10 can maintain flat by means of the support 102. The support 102 according to the present preferred embodiment can also be applied to the one in FIG. 1A, and will not be described further.

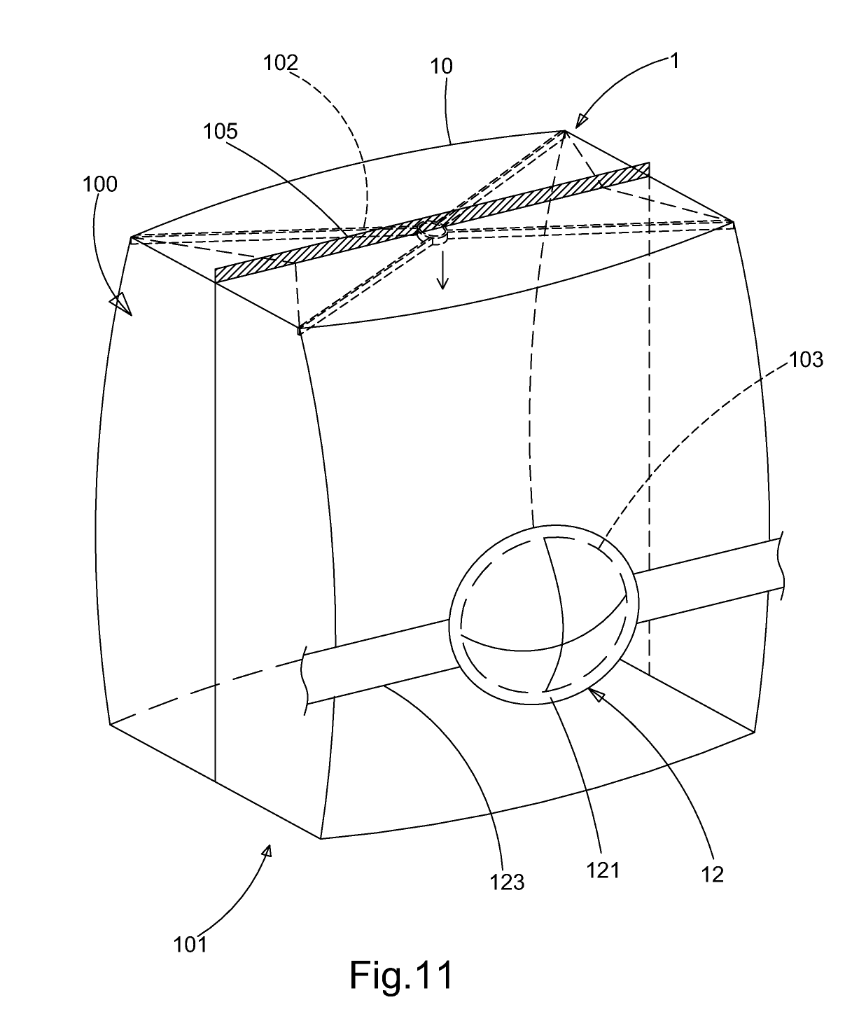

FIG. 11 shows a three-dimensional exterior view of the full-face respirator according to another preferred embodiment of the present invention. As shown in the figure, following the preferred embodiment of FIG. 10, the support 102 can be umbrella skeleton made of hard materials. Thereby, the top of the respirator body 10 can maintain flat by means of the support 102.

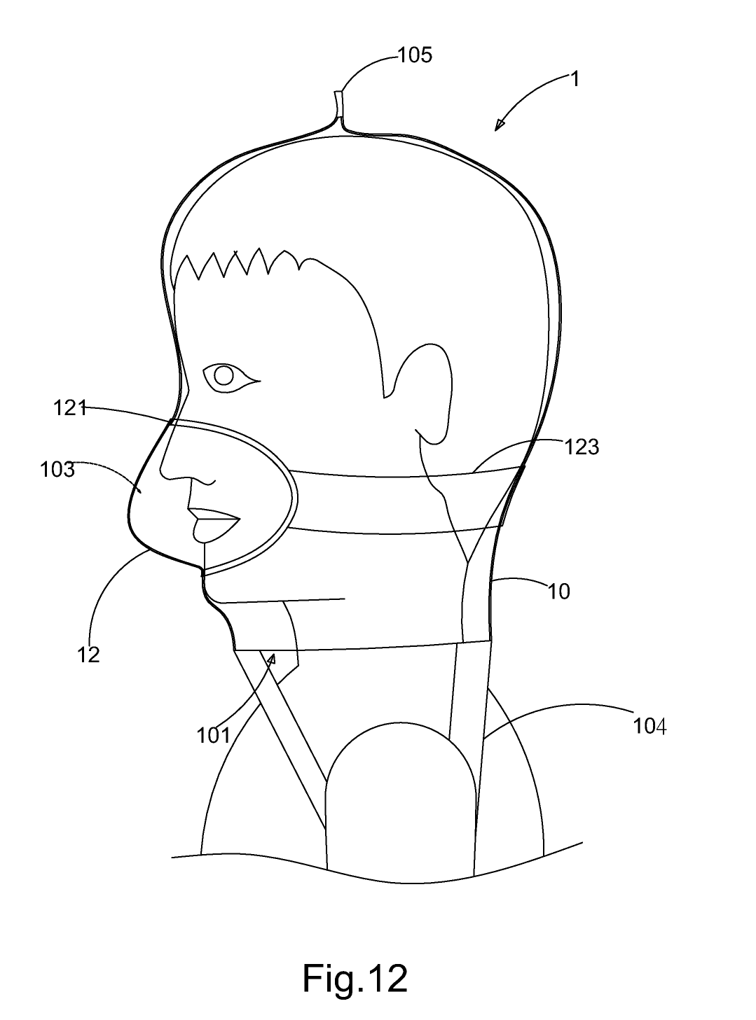

FIG. 12 shows an application view of the full-face respirator according to another preferred embodiment of the present invention. As shown in the figure, following the preferred embodiment of FIG. 3A, the respirator body 10 further includes two belts 104 set on both sides of the wearing opening 101, respectively. When the user wears the full-face germproof respirator 1, his/her hands can pass through said two belts 104 for securing the full-face germproof respirator 1.

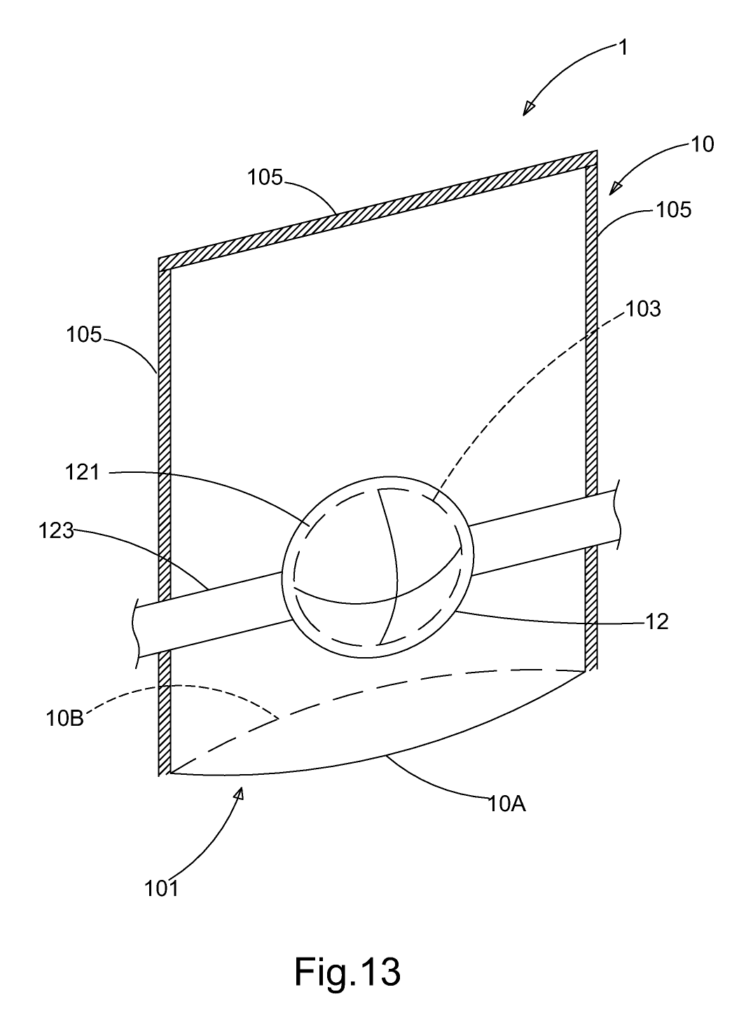

FIG. 13 shows a three-dimensional exterior view of the full-face respirator according to another preferred embodiment of the present invention. As shown in the figure, the respirator bodies 10 of the full-face germproof respirators 1 provided in the preferred embodiment of FIGS. 1A to 11 adopt the same material. In order to make the user of the full-face germproof respirator 1 have a better visibility, the surface of the respirator body 10 having the assembly opening 103 should be transparent. In addition, because the whole respirator body 10 should be made by the same material, the whole respirator body 1 is made transparent. Thereby, the material thereof is transparent plastic film. Because this material does not allow ventilation, when the full-face germproof respirator 1 is used for a long time, the user's visibility is deteriorated owing to mists produced by respiration.

The difference between the full-face germproof respirator 1 according to the present preferred embodiment and the one according to the previous preferred embodiments is that, according to the present preferred embodiment, two materials comprise the respirator 10. The respirator 10 includes a first assembly sheet 10A and a second assembly sheet 10B. The material of the first assembly sheet 10A is a transparent plastic film, and having the assembly opening 103 thereon. The three-dimensional mask 12 is assembled on the assembly opening 103. The material of the second assembly sheet 10B is a moisture-absorbing and sweat-ventilative material or a ventilative material with filtering capability. Thereby, when the user wears the full-face germproof respirator 1, sultry or other uncomfortable feelings will not occur. The first and the second assembly sheets 10A, 10B joint, leaving an opening as the wearing opening 101. Other openings are sealing openings 105. Thus, mists produced by the user when wearing the full-face germproof respirator 1 can be reduced. The present preferred embodiment can be applied to previous preferred embodiments, and the detailed will be described further.

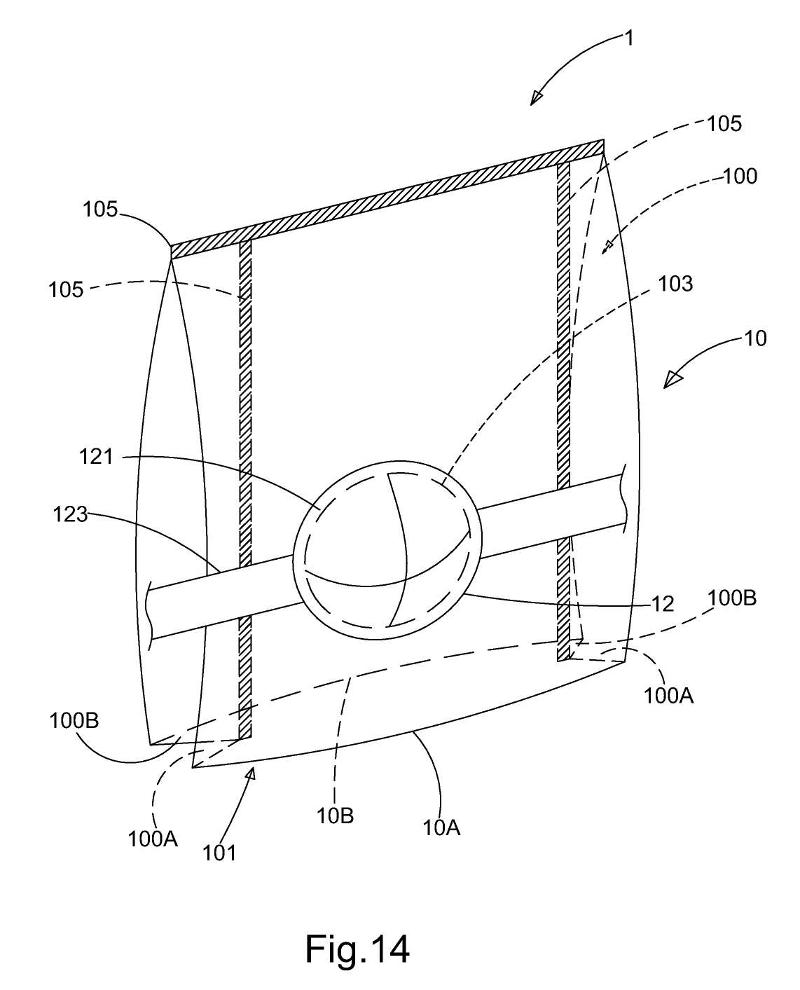

FIG. 14 shows a three-dimensional exterior view of the full-face respirator according to another preferred embodiment of the present invention. The difference between the full-face germproof respirator 1 according to the present preferred embodiment and the one according to the preferred embodiment of FIG. 12 is that, according to the present preferred embodiment, two folded surfaces 100A are set on both flanks of the first assembly sheet 10A, and two folded surfaces 100B are set on both flanks of the second assembly sheet 10B as well. Said two folded surfaces 100A of the first assembly sheet 10A connect with said two folded surfaces 100B of the second assembly sheet 10B. An opening is reserved as the wearing opening 101, and other openings are the sealing openings 105. Because of the folded surfaces 10A, 100B on the respirator body 10, when the respirator body 10 extends, a flat surface is formed on the top thereof, increasing the volume of the respirator body 10. Thereby, in comparison with the respirator body 10 provided by the preferred embodiment of FIG. 12, fewer mists would be produced. The present preferred embodiment can be applied to the previous preferred embodiments, and will not be described further.

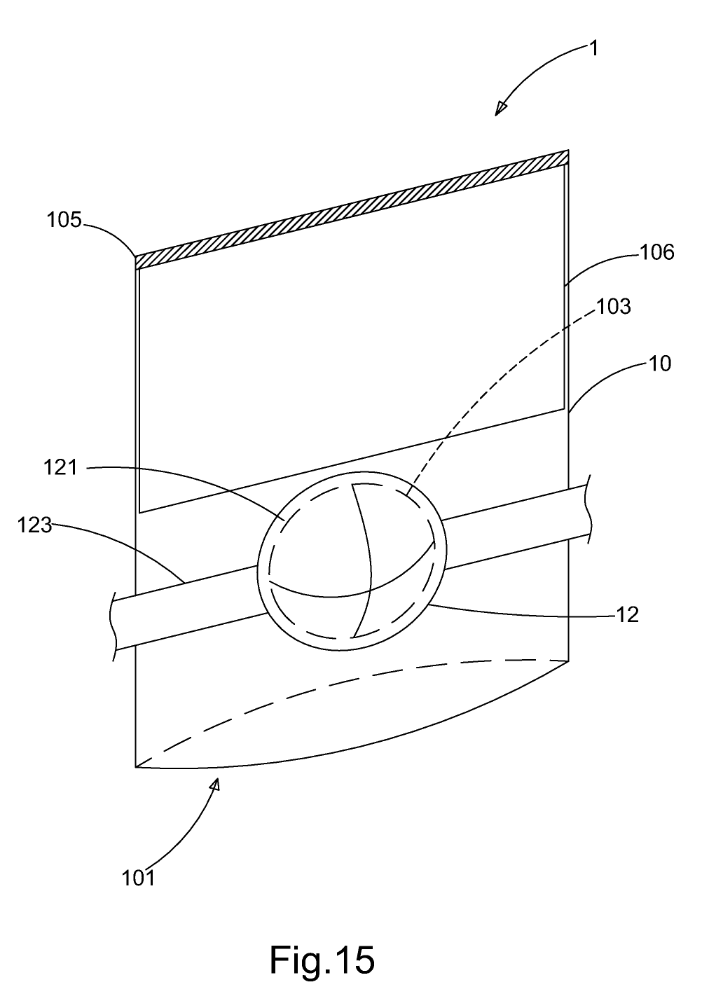

FIG. 15 shows a three-dimensional exterior view of the full-face respirator according to another preferred embodiment of the present invention. As shown in the figure, the present preferred embodiment provides a full-face germproof respirator 1, which comprises a respirator body 10 and a three-dimensional mask 12. The respirator body 10 includes a wearing opening 101, an assembly opening 103, and one or more sealing openings 105. The difference between the present preferred embodiment and the one in FIG. 3A is that the former has a transparent part 106 set on the assembly opening 103. When the user uses the full-face germproof respirator 1, he/she still can see clearly his/her surroundings. The area of the transparent part 106 according to the present preferred embodiment is half the area of the side of the respirator body 10 with the wearing opening 101.

To sum up, the present invention provides a disposable full-face germproof respirator with excellent germproof effects and reducing mist production due to respiration. In order to achieve the effects described above, the full-face germproof respirator according to the present invention features:
1. The full-face germproof respirator is made of simple materials with an easy assembly process. Thereby, the manufacturing cost is low.
2. Except for the wearing opening and the assembly opening, other openings, the joint between the assembly opening and the three-dimensional mask, and other joints are heat-sealed high-frequency waves or ultrasonic waves. Thereby, when the user wears the full-face germproof respirator, external germs or viruses can be avoided from entering the full-face germproof respirator, and hence the user's health will not be harmed.
3. The three-dimensional mask is adopted for allowing a greater zoom for respiration. Thus, mist production while wearing the full-face germproof respirator will be reduced.
4. The respirator body has a fixing part used for fixing the respirator body and the three-dimensional mask. Thereby, the three-dimensional mask can cover the user's mouth and nose completely. Movements of the respirator body are avoided, and thus movements of the three-dimensional mask are prevented accordingly. Hence, external germs or viruses can be avoided from entering the full-face germproof respirator.
5. The respirator further has two folded surfaces, enlarging the unfolded volume of the respirator body. Thereby, the respirator body less tends to press close to the user's face, and mist production while wearing the full-face germproof respirator can be reduced. In addition, in order to maintain the unfolded volume of the respirator body as well as to be convenient for wearing, a support is set on the top of the respirator body.
6. The materials of the respirator body can be transparent plastic films or be made of transparent films and moisture-absorbing and sweat-ventilative materials. When the materials of the respirator are transparent films, because the material if less ventilative, after wearing the respirator body for a long time, it is easier to produce mists due to the user's respiration. Thereby, the respirator body according to the present invention can be made of transparent plastic films and moisture-absorbing and sweat-ventilative materials. One side of the respirator body is a transparent plastic film for enhancing the user's visibility. The other side of the respirator body is made of moisture-absorbing and sweat-ventilative materials for reducing mist production while wearing the full-face germproof respirator.

Accordingly, the present invention conforms to the legal requirements owing to its novelty, non-obviousness, and utility. However, the foregoing description is only a preferred embodiment of the present invention, not used to limit the scope and range of the present invention. Those equivalent changes or modifications made according to the shape, structure, feature, or spirit described in the claims of the present invention are included in the appended claims of the present invention.

1. A full-face germproof respirator, comprising:
a respirator body, including a wearing opening, one or more sealing openings, and an assembly opening, the sealing openings are heat-sealed, and the side of the respirator body with the assembly opening having a transparent part; and
a three-dimensional mask, set on the assembly opening, the rim of the three-dimensional mask being heat-sealed to the assembly opening, having one or more straps located on the outer sides of the respirator body.

2. The full-face germproof respirator of claim 1, wherein the other side of the respirator body has one more fixing parts.

3. The full-face germproof respirator of claim 2, wherein the fixing part is a hook.

4. The full-face germproof respirator of claim 3, wherein the material of the fixing part is a hard material.

5. The full-face germproof respirator of claim 4, wherein the hard material is plastics or metals.

6. The full-face germproof respirator of claim 3, wherein the material of the fixing part is aluminum, iron, or other elastic materials.

7. The full-face germproof respirator of claim 2, wherein the fixing part comprises:
a fixing strap, one end thereof being fixed on the respirator body, and the other end thereof having a buckle insert; and
a buckle member, jointing the buckle insert.

8. The full-face germproof respirator of claim 1, wherein the respirator body further comprises a shoulder shield adjacent to the wearing opening.

9. The full-face germproof respirator of claim 1, wherein inward folded surfaces are further set on both flanks of the respirator body, and forming a flat surface on the top of the respirator body when respirator body is unfolded.

10. The full-face germproof respirator of claim 1, wherein a support is further set on the top of the respirator body for supporting the top thereof.

11. The full-face germproof respirator of claim 1, wherein one end of the strap is set on one side of the three-dimensional mask, and the other end thereof is set on the other side of the three-dimensional mask.

12. The full-face germproof respirator of claim 11, wherein the strap is an elastic strap.

13. The full-face germproof respirator of claim 1, wherein the strap includes:
a first strap, set on one side of the three-dimensional mask; and
a second strap, set on the other side of the three-dimensional mask.

14. The full-face germproof respirator of claim 13, wherein the first strap and the second strap are male and female velcros, respectively.

15. The full-face germproof respirator of claim 13, wherein the first strap and the second strap are straps with male and female buckles, respectively.

16. The full-face germproof respirator of claim 1, wherein the material of the respirator body is a transparent plastic film.

17. The full-face germproof respirator of claim 1, wherein the respirator body includes a first assembly sheet and a second assembly sheet, and the assembly opening is set on the first assembly sheet.

18. The full-face germproof respirator of claim 17, wherein the material of the first assembly sheet is a transparent plastic film.

19. The full-face germproof respirator of claim 17, wherein the material of the second assembly sheet is a moisture-absorbing and sweat-ventilative material or a ventilative material with filtering capability.

20. The full-face germproof respirator of claim 17, wherein both flanks of the first assembly sheet have first folded surfaces, respectively, both flanks of the second assembly sheet have second folded surfaces, respectively, said two first folded surfaces of the first assembly sheet joint said two second folded surfaces of the second assembly sheet, respectively, and the joints of said two first folded surfaces of the first assembly sheet and said two second folded surfaces of the second assembly sheet are the sealing openings.

21. The full-face germproof respirator of claim 1, wherein the three-dimensional mask includes a joint part located on the rim of the three-dimensional mask, and jointing the assembly opening.

22. The full-face germproof respirator of claim 1, wherein the respirator body further includes two belts located on both sides of the wearing opening of the respirator body, respectively.
